(19) United States
(12) Patent Application Publication
(10) Pub. No.: US 2019/0289898 A1
(43) Pub. Date: Sep. 26, 2019

(54) HEAVIES REMOVAL DEVICE FOR TOBACCO AIRFLOW SEPARATOR

(71) Applicant: Evans MacTavish Agricraft, Inc., Wilson, NC (US)

(72) Inventor: Sam Levy, Chesterfield, VA (US)

(21) Appl. No.: 16/130,045

(22) Filed: Sep. 13, 2018

Related U.S. Application Data
(60) Provisional application No. 62/648,099, filed on Mar. 26, 2018.

(51) Int. Cl. A24B 5/10; B07B 4/08; B07B 4/02; B07B 9/02

(52) U.S. Cl. CPC A24B 5/10; B07B 4/08; B07B 2201/02; B07B 9/02; B07B 4/025

(57) ABSTRACT

A heavies removal device including a frame supporting a transporter, a perforated sheet, and an opposing weight. A plurality of upper arms pivotally connect the transporter with the frame and a matching number of lower arms pivotally connect the opposing weight to the frame. Air is directed through the perforated sheet. A drive assembly, including a motor and an eccentric bearing, drive the arms in an upward and forward fashion. As lamina is fed onto the infeed end of the perforated sheet, each forward stroke of the upper arms throws the lamina upward and forward toward the discharge end of the sheet. Vanes on the perforated sheet direct the air as needed to the forward of the sheet to achieve the desired transport. The heavies are transported to the discharge end of the device where they are removed and may afterward be sent through to the next phase of processing.

This application claims the priority of Provisional U.S. Patent Application Ser. No. 62/648,099 filed Mar. 26, 2018

### FIELD OF THE INVENTION

The present invention relates to the separation of lighter and heavier materials, and specifically to an apparatus for separating tobacco leaf into clear lamina and heavies.

### BACKGROUND OF THE INVENTION

Tobacco lamina must be classified and separated prior to the production of cigarettes. A conventional pneumatic separator is a substantially large and complex machine that typically includes a fabric perforated conveyor belt or perforated metal apron carrying the feed tobacco through multiple separation chambers. Conventional pneumatic separators include a substantial amount of moving parts, such as conveyors, sprockets, chains, and aprons that required a substantial amount of maintenance to keep the separators running. Conventional aprons are problematic and are not effective in removing the heavier materials, typically referred to as “heavies”.

Accordingly, there is a need for removing heavies from the lamina. The heavies removal device preferably would consume less power and have substantially less parts. The heavies removal device would be lighter, have less moving parts, reduce the static load on the fan, reduce downtime and maintenance, eliminate the need for frequent cleaning, and efficiently remove the heavies from the separator.

### BRIEF SUMMARY OF THE INVENTION

The invention is a heavies removal device for transporting heavies out of the separator. The heavies removal device includes a frame supporting a transporter including a perforated sheet and an opposing weight. A plurality of upper arms pivotally connect the transporter with the frame and a matching number of lower arms pivotally connect the opposing weight to the frame. A flow of air is directed through the perforated sheet. A drive assembly, including a motor and an eccentric bearing, drive the arms in an upward and forward fashion. As lamina is fed onto the infeed end of the perforated sheet, each forward stroke of the upper arms throws the lamina upward and forward toward the discharge end of the sheet. Vanes on the perforated sheet direct the air as needed to the forward of the sheet to achieve the desired transport. The heavies are transported to the discharge end of the device where they are removed and may afterward be sent through the next processing phase.

### OBJECTS AND ADVANTAGES OF THE INVENTION

The heavies removal device of the present invention exhibits several advantages over conventional recirculating pneumatic separators, including:
1) The heavies removal device is a much lighter system.
2) Several moving parts of conventional separators are eliminated, such as the apron, sockets, and chains.
3) Maintenance costs are greatly reduced.
4) The need for cleaning the machine is greatly reduced.
5) The heavies removal device greatly reduces the static load on the fan as compared to conventional machines, thereby providing power savings during operation.

These and other objects and advantages of the present invention will be better understood by reading the following description along with reference to the drawings.

### BRIEF DESCRIPTION OF THE SEVERAL VIEWS OF THE DRAWING(S)

Reference is made herein to the accompanying drawings, which are not necessarily drawn to scale, and wherein:

FIG. 1 is a side view depicting the internal layout of a heavies removal device for a linear airflow separator, in accordance with embodiments of the invention.

FIG. 2 is an isometric view of the heavies removal device.

FIG. 3 is a top view of the heavies removal device.

FIG. 4 is an end view of the heavies removal device from the infeed end.

FIG. 5 is a side view of the heavies removal device.

FIG. 6 is a sectional view taken along line 6-6 of FIG. 5.

FIG. 7 is a sectional view taken along line 7-7 of FIG. 3 and depicting a cross member that forms a portion of the heavies removal device of FIG. 1.

FIG. 8 is an isometric view of a drive link assembly that forms a portion of the heavies removal device of FIG. 1.

FIG. 9 is a plan view of the drive link assembly.

FIG. 10 is a side view of the drive link assembly.

FIG. 11 is an isometric view of a transporter arm that forms a portion of the heavies removal device of FIG. 1.

FIG. 12 is a plan view of the transporter arm.

FIG. 13 is a side view of the transporter arm.

FIG. 14 is an end view of the transporter arm.

FIG. 15 is a side view of the heavies removal device including an air input plenum and an air output plenum for ducting an air flow through the device.

FIG. 16 is an isometric view of the heavies removal device fitted the input plenum and an air output plenum.

### DETAILED DESCRIPTION

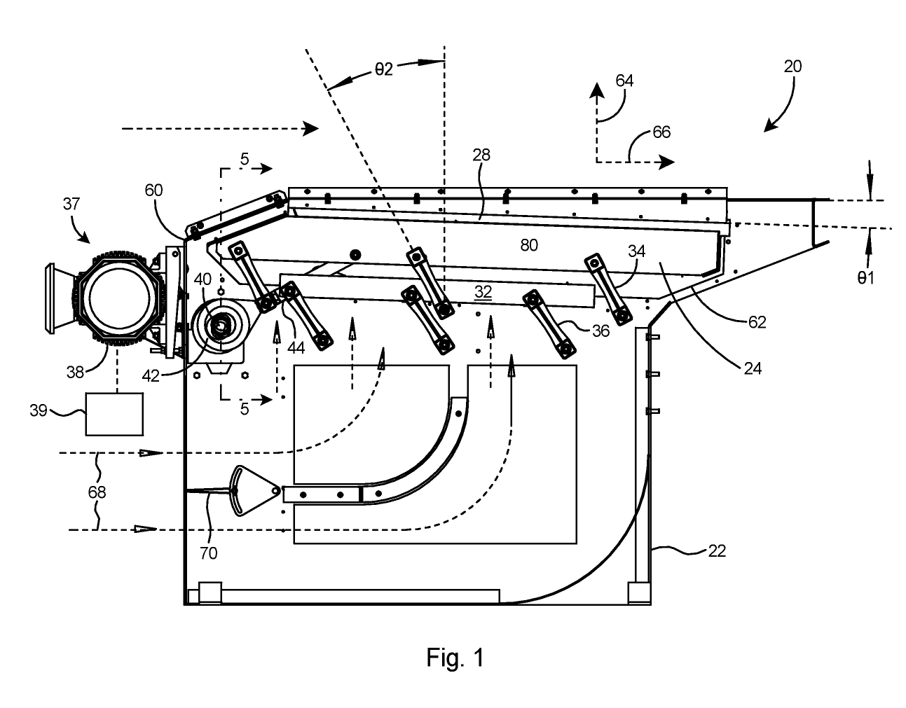

With reference to FIG. 1, there is shown a preferred embodiment of a heavies removal device 20 for a linear airflow separator in accordance with the present invention. The heavies removal device 20 includes a housing or frame 22 supporting a transporter 24 having a perforated sheet 28 and an opposing weight 32. One or more upper arms 34 pivotally connect the transporter 24 with the frame 22 and a matching number of lower arms 36 pivotally connect the opposing weight 32 to the frame 22.

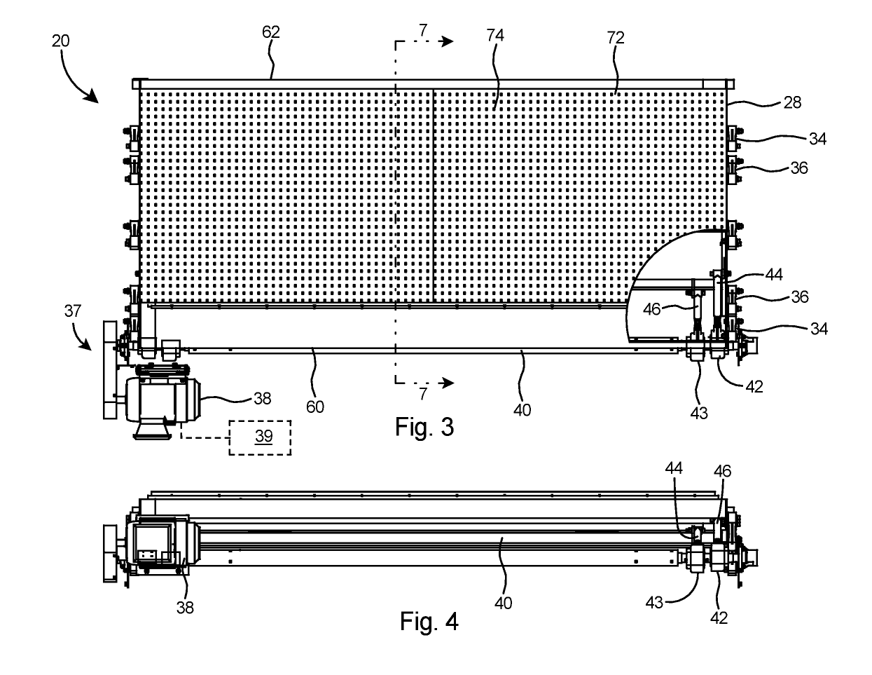

As shown in FIG. 3, each upper arm 34 and lower arm 36 includes a matching arm on the opposing side of the heavies removal device 20. The heavies removal device 20 further includes a drive assembly 37 including a motor 38 with a variable frequency drive 39 for driving a drive shaft 40 which in turn drives two eccentric bearings 42 and 43 on each side of the device.

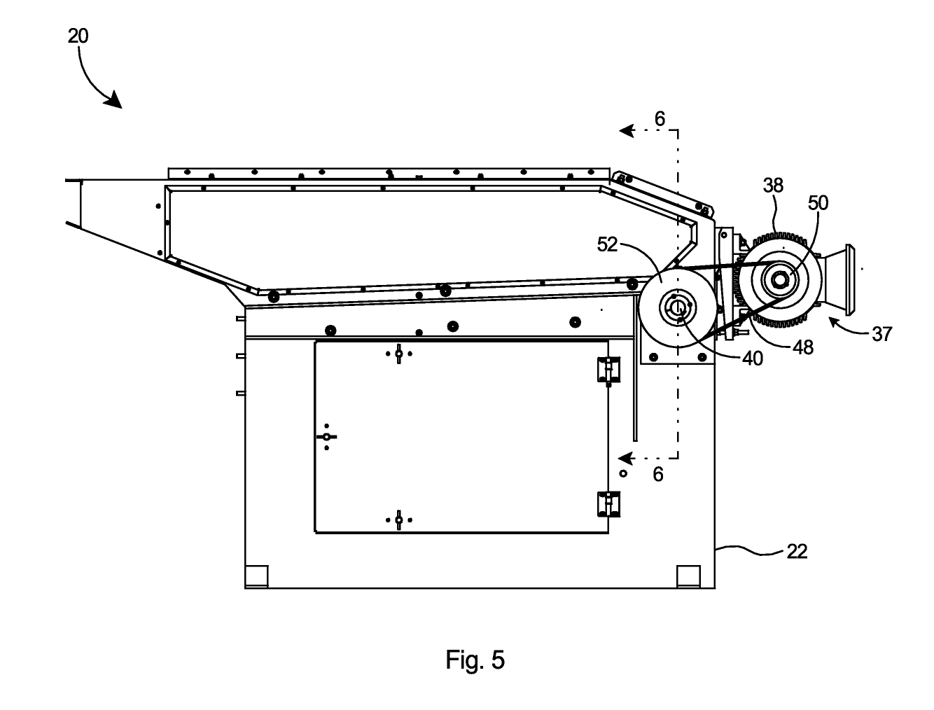

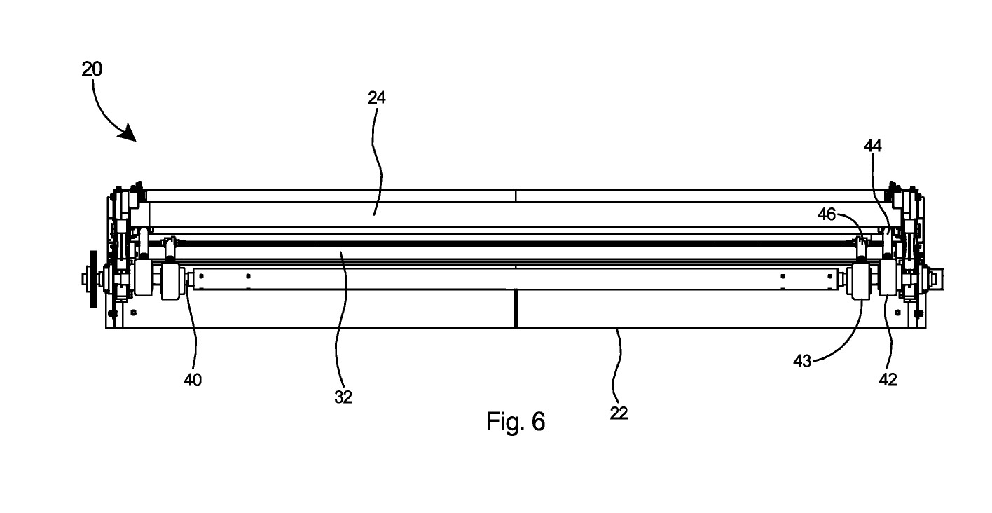

Referring to FIG. 6, a first drive link assembly 44 connects the first eccentric bearing 42 to the transporter 24 and a second drive link assembly 46 connects the second eccentric bearing 43 to the opposing weight 32. As shown in FIG. 5, the drive assembly 37 further includes a belt 48 running between a drive sheave 50 and a driven sheave 52.

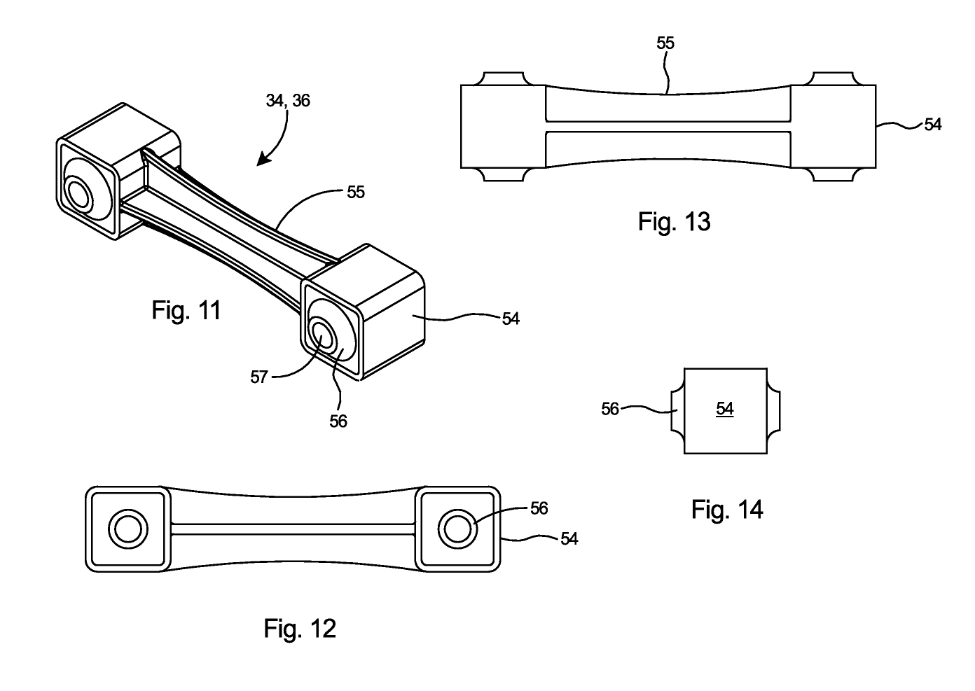

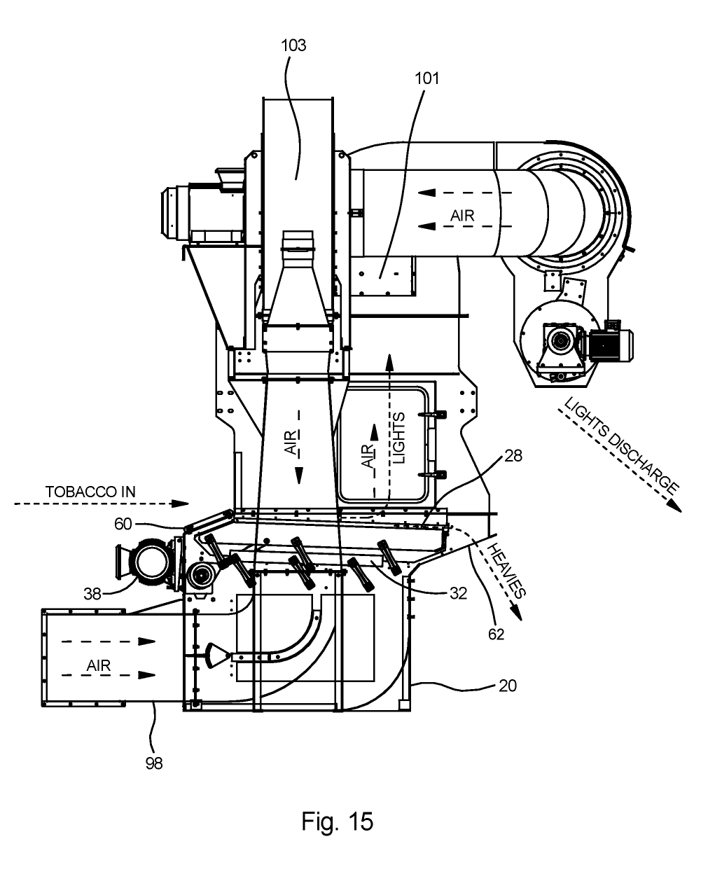

With reference to FIGS. 11-14, each of the arms 34 and 36 include two ends 54 linked by a connecting arm 55. Each end 54 includes a rubber bushing 56 with a through bore 57 therein. As shown in FIG. 1, each of the upper arms 34 is pivotally mounted at one end to the transporter 24 and the opposing end is connected to the frame 22. Each of the lower arms 36 is pivotally mounted at one end to the opposing weight 32 and at the opposing end to the frame 22. The purpose of the opposing weight 32 is to counteract the movement of the transporter 24 and thus stabilize the machine, so it doesn't jump around.

Referring to FIG. 1, the drive means of the heavies removal device provides a transporting system for removing the heavies, including the stems, which may then be sent through the next phase of processing unseparated lamina. As shown in FIG. 1, the heavies removal device 20 includes an infeed end 60 for feeding unseparated lamina onto the perforated sheet 28 and a discharge end 62 for discharging heavies and stems from the sheet.

With reference to FIG. 4, as the motor 38 drives the drive shaft 40, the eccentric bearings 42 and 43 drive the drive link assemblies 44 and 46 repeatedly. As shown in FIG. 1, the perforated sheet 28 is first driven in an upward direction, as indicated by directional arrow 64, while at the same time being driven in a forward direction, as indicated by directional arrow 66, or toward the discharge end 62. In the following stroke the perforated sheet 28 is driven downward and rearward toward the infeed end 60. The frequency of the motor 38 is adjusted by the variable frequency drive 39 (see FIG. 1) to control the speed of transport of the heavies. Most preferably, the vertical travel of the perforated sheet 28 is at least 0.404 inches and the horizontal travel is at least 0.629 inches. Preferably the perforated sheet 28 is angled downward toward the discharge end 62, most preferably at an angle θ1 of 2 degrees from horizontal. The drive mechanism thus imparts a repetitive forward and backward motion to the arms 34 and 36, with the upper arms and lower arms moving at the same time but 180° apart. The transporter 24 and upper arms 34 form a transporter assembly and the lower arms 36 and opposing weight 32 form an opposing weight assembly.

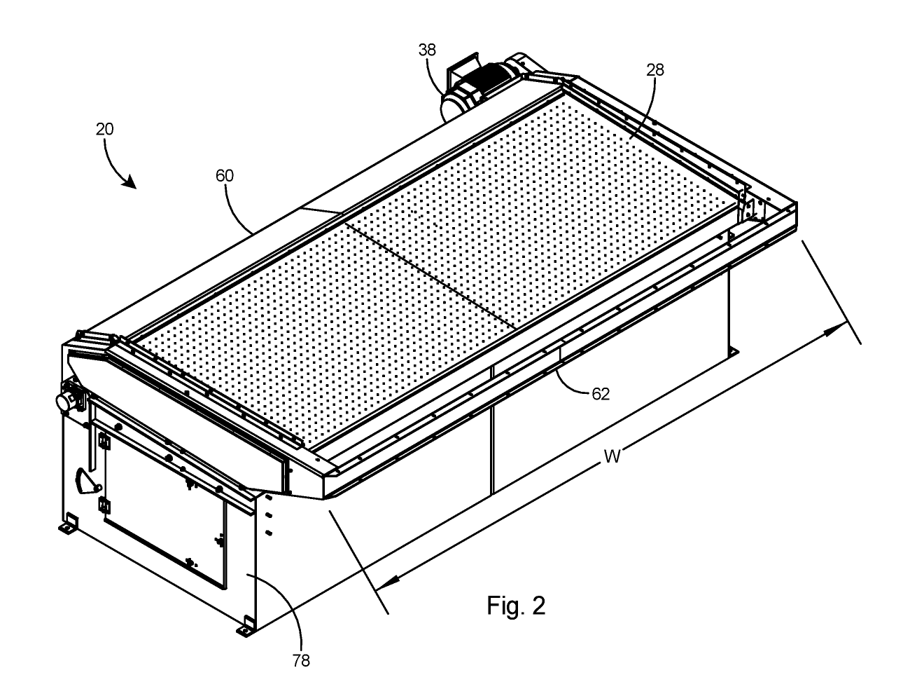

With further reference to FIG. 1, the heavies removal device 20 preferably includes an input air flow 68 that is ducted to flow through the perforated sheet 28. An air deflector 70 can be manipulated to adjust air flow as desired to balance air flow between the front and rear of the perforated sheet 28. As shown in FIG. 2, the heavies removal device 20 can be produced in various widths Win order to supply a desired throughput. Typical machine widths are 4, 5, 6, 8, 10, and 12 feet wide, although other widths are possible.

Preferably, there is a 2:1 gear reduction between the motor and the drive shaft, i.e. the drive shaft 40 runs at a reduced speed than the motor 38although it is within the scope of the invention to provide gearing to step up or step down the rpms of the drive shaft with respect to the rpms of the motor. The speed of the drive shaft 40 is adjustable by the variable frequency drive 39. The upper arms 34 pivotally connect the transporter 24 with the frame 22 and a matching number of lower arms 36 connect the opposing weight 32 to the frame. Each upper arm 34 on each side of the machine is paired with a corresponding lower arm 36 on that side. The lower arm 36 in each pair of arms is carefully adjusted to match the stroke of the upper arm 34 in that pair.

A preferred speed of rotation of the motor and drive shaft would be 480-530 RPM, with the speed of transport adjusted as desired with the variable frequency drive. Each full rotation of the drive shaft 40 translates into two strokes of the arms, with the first stroke driving the upper arms 34 and perforated sheet 28 forward and upward while at the same driving the lower arms 36 rearward and downward. In such a manner, the lamina is repeatedly thrown upward and forward, or toward the discharge end 62, by the movement of the perforated sheet 28. The slightly downward angle of the discharge end 62 of the perforated sheet with respect to the infeed end 60 assists in moving the lamina toward the discharge end. Most preferably, each upper arm 34 and lower arm 36 includes a travel distance of 28 to 33 degrees from vertical as shown by angle θ2 in FIG. 1, with the top of each arm slanted toward the infeed end 60 and the bottom of each arm slanted toward the discharge end 62.

Referring to FIG. 3, the perforated sheet 28 is preferably constructed of steel, includes a smooth top surface 72, and a plurality of regularly spaced apertures 74 therein. Most preferably the apertures are ⅛ inch in diameter, which creates a perforated sheet with a 40% open area.

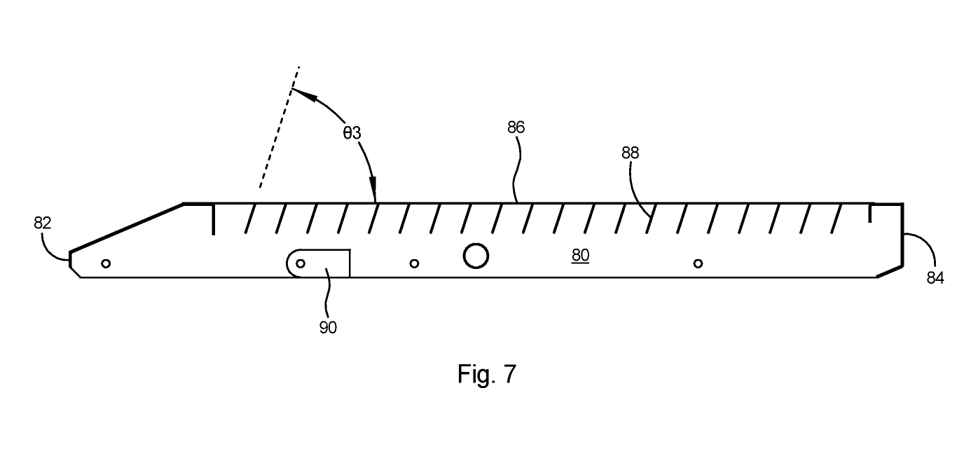

As shown in FIG. 2, each side 78 of the housing 22 includes a side plate 80 supporting the perforated sheet 28 with the upper arms 34. As shown in FIG. 7, the side plate 80 includes a feed end 84, a discharge end 82, and a top surface 86. A plurality of stiffeners 88 extend between the side plates 80. The stiffeners 88 are at an angle with respect to the top surface 86. Most preferably the stiffeners 88 are at an angle of θ3 degrees with respect to the top surface 86. A link mount block 90 on the side plate 80 provides a reinforced portion of the side plate for attachment of a cross member (not shown). Most preferably, the stiffeners 88 are at an angle of from 70 to 74 degrees with respect to the top surface 86.

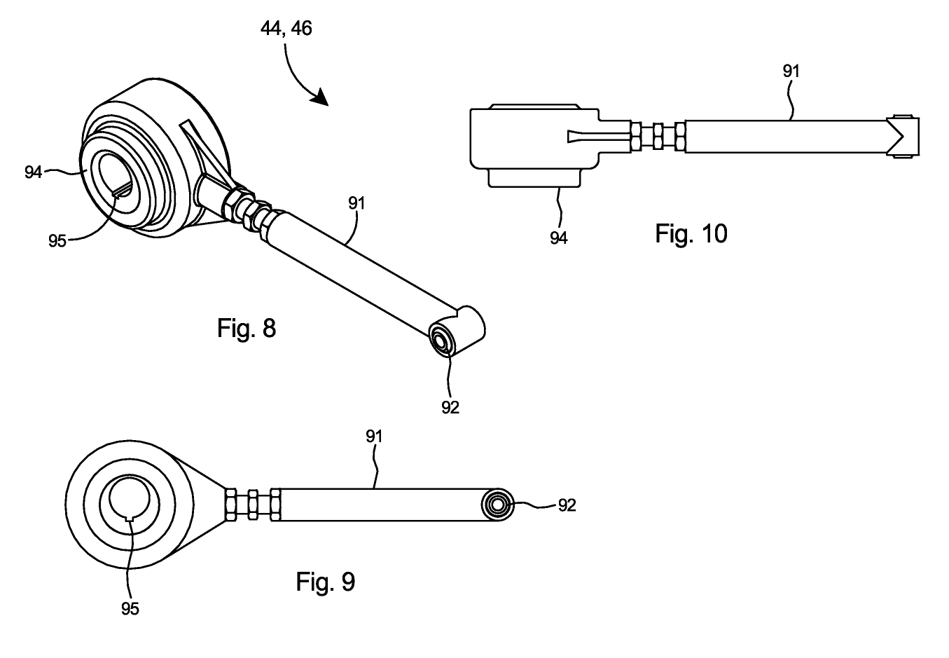

With reference to FIGS. 8-10, each drive link assembly 44 and 46 includes a central arm 91, a bushing 92 and a bearing 94. As shown in FIG. 6, bearing 94 of each drive link assembly 44 and 46 connects to the drive shaft 40 and bushing 92 connects to a link 96 connecting the transporter and the opposing weight. The inner periphery of bearing 94 is keyed 95 to facilitate connection to the drive shaft 40.

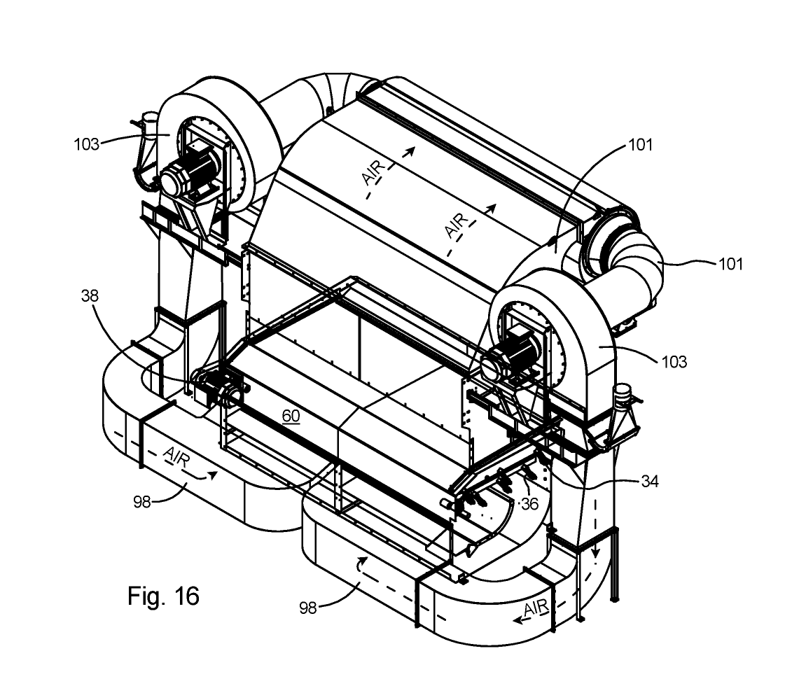

Referring to FIGS. 15 and 16, the heavies removal device 20 includes an air input plenum 98 and an air output plenum 101 for providing air flow through the device. In operation air is forced by a fan or blower 103 through the input plenum 98, through the perforated sheet 28, and into the output plenum 101, after which the air is recycled through the device. Tobacco with stems are fed into the infeed end 60 of the heavies removal device 20 and are transported down the perforated sheet 28 during each forward stroke of the perforated sheet 28. The forward strokes of the perforated sheet and the air flow through the perforated sheet 28 separate the lamina into clear lamina (lights) and heavies. The clear lamina is transported upward to be removed from the device and the heavies, including the stems, are discharged from the discharge end 62 and are sent through a thresher (not shown) for reprocessing.

Referring to FIG. 1, each side of the heavies removal device includes a plurality of upper arms 34 each matched with an opposing lower arm 36. Each lower arm 36 is constructed to be slightly lighter in weight than its matching upper arm 34 but within a specified weight as of the matching upper arm. Thus weight can later be added to any of the respective lower arms 36 in order to dampen the overall vibration to the heavies removal device.

As compared to conventional separators, the heavies removal device of the present invention eliminates the need for an apron and reduces the static load on the blower, thereby providing power savings as compared to conventional separators. Additionally there are much less moving parts than in prior art separators, thereby leading to less maintenance and cleaning.

Having thus described the invention with reference to a preferred embodiment, it is to be understood that the invention is not so limited by the description herein but will be defined by the claims. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments herein were chosen and described in order to best explain the principles of the invention and the practical application, and to enable others of ordinary skill in the art to understand the invention.

What is claimed is:

1. A heavies removal device for transporting heavies out of a separator, comprising:
a frame;
a transporter supporting a perforated sheet having a top surface;
an opposing weight for countering the movement of the transporter and stabilizing the heavies removal device;
a drive assembly for driving said transporter and said perforated sheet; and
one or more arms connecting said transporter to said drive assembly and said opposing weight.

2. The heavies removal device of claim 1 wherein said drive assembly further comprises:
a drive shaft; and
an eccentric bearing.

3. The heavies removal device of claim 2 further comprising a drive link assembly connecting said eccentric bearing to a first of said arms.

4. The heavies removal device of claim 1 further comprising:
an infeed end and a discharge end; and
said perforated sheet is sloped downward at an angle from said infeed end toward said discharge end.

5. The heavies removal device of claim 4 wherein said angle of said perforated sheet is 2 degrees.

6. The heavies removal device of claim 1 wherein said arms further comprise upper arms and lower arms.

7. The heavies removal device of claim 6 further comprising:
said upper arms pivotally connected at one end to said transporter; and
said upper arms pivotally connected at an opposing end to said frame.

8. The heavies removal device of claim 1 further comprising:
said lower arms pivotally connected at one end to said opposing weight; and
said lower arms pivotally connected at an opposing end to said frame.

9. The heavies removal device of claim 1 wherein said drive assembly further comprises a variable frequency drive.

10. The heavies removal device of claim 1 further comprising:
said perforated sheet includes a bottom surface; and
a plurality of stiffeners extending across said bottom surface of said sheet.

11. The heavies removal device of claim 1 further comprising:
a side plate supporting the perforated sheet; and
a plurality of stiffeners extend between the side plates.

12. The heavies removal device of claim 1 further comprising:
the stiffeners are at an angle with respect to the top surface of the perforated sheet; and
the stiffeners are at an angle of 70 to 74 degrees with respect to the top surface.

13. The heavies removal device of claim 1 further comprising
a plurality of regularly spaced apertures in said perforated sheet;
said perforations are 0.125-inch in diameter; and
said perforated sheet including 40 percent open area as a result of said regularly spaced apertures.

14. The heavies removal device of claim 6 including comprising:
each of said upper arms is matched with an opposing lower arm; and
said opposing lower arm being lighter in weight than the matched upper arm enabling the addition of weight to any of said lower arms in order to dampen the overall vibration to the heavies removal device.

15. A heavies removal device for transporting heavies out of a separator, comprising:
a frame;
a transporter supporting a perforated sheet having a top surface;
an opposing weight for countering the movement of the transporter and stabilizing the heavies removal device;
a drive assembly for driving said transporter and said perforated sheet;
one or more arms connecting said transporter to said drive assembly and said opposing weight;
said arms include upper arms and lower arms;
said upper arms pivotally connected at one end to said transporter; and
said upper arms pivotally connected at an opposing end to said frame

16. The heavies removal device of claim 15 comprising
said lower arms pivotally connected at one end to said opposing weight; and
said lower arms pivotally connected at an opposing end to said frame.

17. The heavies removal device of claim 16 further comprising
each of said upper arms is matched with an opposing lower arm; and
said opposing lower arm being lighter in weight than the matched upper arm enabling the addition of weight to any of said lower arms in order to dampen the overall vibration to the heavies removal device.

18. A heavies removal device for transporting heavies out of a separator, comprising:
a frame;
a transporter supporting a perforated sheet having a top surface, said transporter including an infeed end and a discharge end;
an opposing weight for countering the movement of the transporter and stabilizing the heavies removal device;
a drive assembly for driving said transporter and said perforated sheet;
one or more arms connecting said transporter to said drive assembly and said opposing weight, said arms including top ends;
said arms are oriented away from vertical to include said top ends slanted toward said infeed end of said transporter; and
a drive shaft, an eccentric bearing, and a drive link assembly for imparting a back and forth motion to said arms, said transporter, and said perforated sheet.

19. The heavies removal device of claim 18 comprising said drive assembly imparting an angular travel distance to the arms of 28-33 degrees from vertical.

20. The heavies removal device of claim 19 further comprising said perforated sheet is sloped downward at an angle from said infeed end toward said discharge end.
